(19) United States
(12) Patent Application Publication
(10) Pub. No.: US 2002/0194320 A1
(43) Pub. Date: Dec. 19, 2002

(54) Remote support system

(76) Inventors: Kevin Collins, Fort Collins, CO (US); Bradley Allen Bowlin, Fort Collins, CO (US); Shannon Jenniffer Moyes-Clark, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/881,777

(22) Filed: Jun. 15, 2001

(51) Int. Cl. G06F 15/173

(52) U.S. Cl. 709/223; 709/220

(57) ABSTRACT

A method for enabling remote diagnosis of an active application and its related environment on a client computer from a support location. The method includes the step of requesting a diagnostic information package relating to the active application. The next step is collecting the diagnostic information package relating to the active application, using a procedural interface that programmatically collects the diagnostic information package. Another step is sending the diagnostic information package to the support location in response to the request for the diagnostic information package.

### FIELD OF THE INVENTION

The present invention relates generally to the diagnosis and troubleshooting of software applications. More particularly, the present invention relates to providing a support tool that allows access to and diagnosis of information about an active software application.

### BACKGROUND

Computer software has become increasingly important in the computer industry and in virtually every other industry as well. The mission critical nature and importance of software requires that software vendors and software developers be able to troubleshoot and diagnose problems quickly and effectively. Unfortunately, after a software application has been deployed, it is very difficult to receive real-time or even timely feedback about the application.

In the computer industry, it has been difficult to provide timely support for users. This is because the most common method of diagnosing a problem for a software application is to have a user call a telephone support site and discuss the problem with the technical support staff. The user is then instructed to perform various tasks and then report the results of those tasks to the support person.

A problem with this system is that users are involved in this telephone feedback loop, whether or not the user understands what they are doing. To add to this problem, it can be difficult for a support technician to describe to the user over the phone what they should do. It is also problematic to explain to a user the meaning of the information that the user is viewing. An event may occur in the application that may have technical significance but the user will never report it because it has no relevance in their mind. This is especially true with users or customers who are less sophisticated.

Another way users have received support is through web pages, support databases, newsgroup postings on Internet sites, or through email. Internet web pages are less than effective if the user does not know how to describe their problem or cannot identify the information they are looking for. Web sites also may not be effective if the problem is overly complex. Email support has the drawback that it provides very slow feedback, and it can be a difficult way to isolate and correct problems. Telephone and email support both have the problem that the accuracy of the data received from the user is very low.

Some systems have been implemented by software developers and vendors to improve the timeliness and accuracy of information collected about application malfunctions. Such programs have error routines that detect when a software application or program abnormally terminates (crashes) on a host operating system. When the application crashes, a graphical window appears and allows the user to send information to a support center. The information sent by the user for the application describes where the program terminated and possibly the function the user was performing. This allows the vendor to receive accurate information about when the application crashes. An example of this type of system is Netscape's Internet browser that implements automated error feedback when the application crashes.

There are some significant drawbacks to this type of information collection system. The first drawback is that the application feedback mechanism is very product specific because it is tied to the error handling routines of a specific application. Furthermore, the feedback is only triggered after the application crashes or a very severe termination event occurs in the application. Information that is collected after an abnormal termination has taken place is suspect because the abnormal termination itself may corrupt the data being sent. Moreover, there may be situations where the program is executing incorrectly, but the program does not abnormally terminate. In this situation, no feedback is generated but it may be desirable to be able to troubleshoot the application.

Another drawback to sending a support message when the program crashes is that the communication is not interactive. The error message and abnormal termination data are essentially email messages sent to the application vendor. After the message is sent to the application vendor, the application vendor is not necessarily directly involved. The vendor and/or their technical support group may choose to respond to the message or to ignore it completely. Regrettably, this does not provide a high level of support for the user.

### SUMMARY OF THE INVENTION

It has been recognized that it would be advantageous to develop a system that enables effective support and problem solving for active software applications. This provides the highest level of customer satisfaction and quality assurance.

Furthermore, it would be valuable to have a system and method for troubleshooting and possibly repairing an application that is applicable to multiple applications. There are significant advantages in being able to support more than one application using the same tools and techniques.

The invention provides a method for enabling remote diagnosis of an active application and its related environment on a client computer from a support location. The method includes the step of requesting a diagnostic information package relating to the active application. The next step is collecting the diagnostic information package relating to the active application, using a procedural interface that programmatically collects the diagnostic information package. Another step is sending the diagnostic information package to the support location in response to the request for the diagnostic information package.

In accordance with another detailed aspect of the present invention, the system enables a support person at a support location to remotely diagnose an active application and its related environment on a client computer. The system comprises a procedural interface that is couplable to the active application. The procedural interface enables the collection of a diagnostic information package concerning the active application and its related environment. The procedural interface further comprises a communications component that is associated with the procedural interface. The communications component is configured to enable transfer of the diagnostic information package to the remote support location. In addition, the diagnostic information package further comprises information about the configuration of the active application, application resources, and system resources used by the active application.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 illustrates the relationship between a customer site and a remote service provider for an active application;

FIG. 2 illustrates the relationship between a customer site and a local support provider for an active application;

FIG. 3 is a block diagram illustrating a user initiated system for collecting and sending diagnostic information package to a support site;

FIG. 4 is a flow chart illustrating a method for user initiated collection and transfer of a diagnostic information package to a support site;

FIG. 5 illustrates the relationship between a customer site and a remote service provider who is pulling a diagnostic information package from the customer site;

FIG. 6 illustrates the relationship between a customer site and a local support provider who is pulling a diagnostic information package from the customer site;

FIG. 7 is a block diagram illustrating a request of a diagnostic information package from an active application at a client site;

FIG. 8 is a flow chart illustrating a method for transferring a diagnostic information package to a support site that is initiated by support personnel.

### DETAILED DESCRIPTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

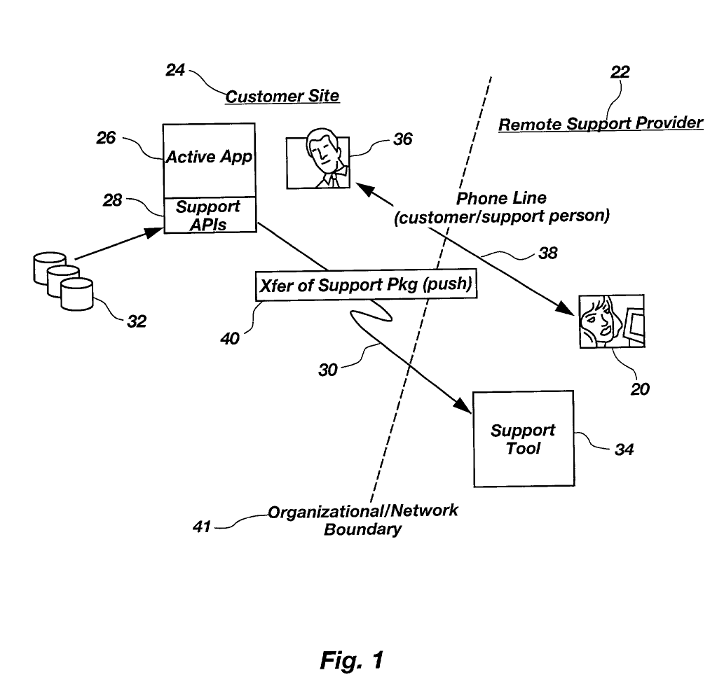

FIG. 1 illustrates a system for allowing a support person 20 or support personnel at a remote support provider site 22 (or support location) to remotely diagnose an active application 26 and its related environment on a client computer at a customer site 24. The support person is likely to be located outside of the customer's organization or local network 41 in this embodiment. An active application executes on an operating system on a client remote computer (not shown).

A procedural interface 28 is coupled to the active application. The procedural interface is enabled to collect a diagnostic information package 40 about the active application 26. This procedural interface can be defined generally as the application programming interfaces (APIs) and the data formats used to create the diagnostic information package.

Active applications 26 make multiple aspects of their system and configuration available to the procedural interface 28 and/or support service. This enables a support person 20 (local or remote) to analyze problems with a set of diagnostic data 32 taken programmatically from the application. Such data includes but is not limited to: all configuration files, installation directory information (directory names, current permission settings, owners etc.), all relevant log files, data taken from the database, and the database itself (depending on the application). In essence, the information is gathered that is necessary for the support person or technician to quickly and accurately do their job. The compilation of this data is generally defined as a diagnostic information package. It should also be noted the word remote in this description is generally defined as the interaction with or support of a computer that is not physically proximate to the user.

The diagnostic information package 40 is requested and received via uniform APIs 28. One uniform and efficient way of formatting and transporting the data may be in an XML-based format. The advantage of using uniform or standard formats is that the APIs can then be used with multiple applications and similar support data may be analyzed for each of those separate applications. Because a full diagnostic information package is provided for the support person, a more in-depth analysis can take place than might otherwise be possible.

The data is packaged in standard formats to enable fine level decomposition of the data in a support tool interface 34 that is used at a remote or local location. The support tool interface can be either a graphic user interface (GUI), character-based interface, a voice activated interface or a similar user interface. The support tool may be a web-enabled GUI used by a remote service provider that is possibly the application provider.

An example of fine level decomposition is a typical support scenario where a support person 20 may request log files and/or configuration files from the procedural interface 28. Log files are conventionally very specific to each application and require a detailed knowledge of the application to understand them. The same is true of configuration data. The current invention allows configuration file settings to be shown in a user-friendly way. Log files may also be presented in a readable format, and relevant portions of the operating system's registry, or important data from the application's database may be viewed.

With the standards in the APIs of the present embodiment, the support tool 34 is able to programmatically understand the active application's configuration and log files. Then this information is presented in an easy to understand format that facilitates support. Accordingly, the support person is better able to understand the logs in finer detail because they are formatted in a standard format. In the preferred embodiment of this invention, the active application's log files are in a standard format as well because it lowers implementation costs and provide wider application compatibility.

Active software applications that can be managed with the present invention may include network management applications, office productivity applications, software development tools, automated desktop management applications, system performance monitors, databases, web servers, firewalls, mail servers, power management applications, and storage management and printing applications.

It is important to note that this invention enables the diagnosis of an active application and not one that has abnormally terminated or is in the process of termination. This allows a support person to properly diagnose the active application with clean data that has not been corrupted by illegal operations as the program terminates. In contrast, some programs (such as Netscape Navigator) send limited information to a support site while they are terminating.

The system also can include a stand-alone service to monitor the application (e.g., to ensure it is running, to start/restart it or services it depends on) and to collect information about the host computer the application is running on (e.g. system load, disk capacity etc.). This separate stand-alone service can be a separate process that runs in the background and diagnoses the active application. It may collect generic information (e.g. file system attributes) about services that the active application depends upon. A separate service is especially valuable for applications that are running on a server that is difficult to access because it might be located in a server-farm or other third party managed location.

Referring again to FIG. 1, a communications component 30 is associated with the procedural interface and it is configured to initiate and control the transfer of the diagnostic information package to a remote support location 22. In this embodiment, the remote tool 34 is located at the remote support provider 22. The customer 36 or user will often be in communication with a support person on the telephone 38. The support person may then ask the customer to activate a function in the active application 26 that initiates the collection of the diagnostic support package(s) 40. This activation may take place through clicking on a button, selecting a menu, or another customer activated event. Alternatively, the user may be in contact with the support personnel by email, instant messaging, wireless telephone, or another communication method, where the customer can be asked to activate the compilation of the diagnostic support package.

In one embodiment of the activation feature, a second user interface (GUI) can be used by the customer. This interface appears when the end user wants to invoke the support/data gathering process that generates the diagnostic information package. The interface allows the user to specify further contextual information that can be used in the problem resolution process. This interface can appear as an option within the menu of support enabled applications, it can be called from an operating system menu, or it may be activated from the command line.

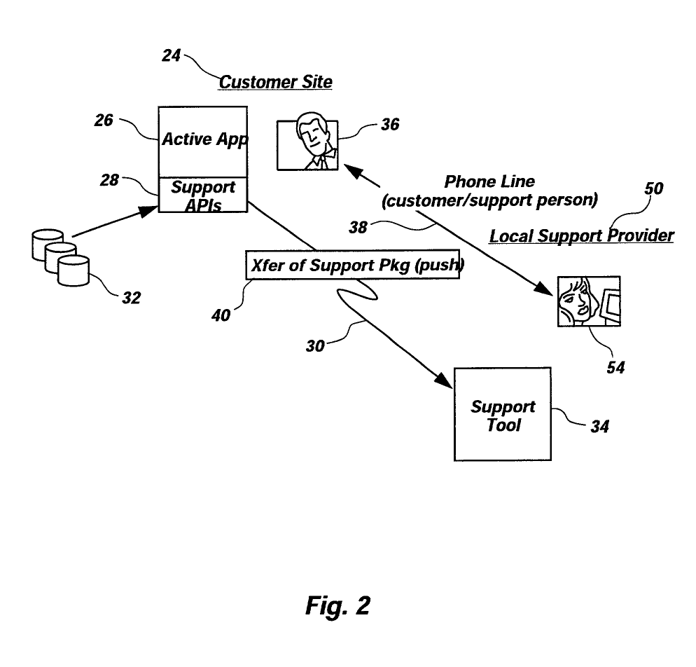

FIG. 2 illustrates the relationship between a customer site 24 and a local support provider 50 for an active application 26. As mentioned above, this invention includes a set of procedural interfaces 28 or APIs so that applications can provide a very high level of supportability. The procedural interfaces include pre-defined formats and guidelines that programmers may use to structure the diagnostic support package sent to the support provider. A user interface (possibly a GUI) is provided and the support person 52 (or support personnel) views the diagnostic support package through the user interface or support tool 34.

In this embodiment, the support tool 34 (e.g., a GUI) is locally based at the customer site “help center”. A local support interface in the local support tool allows a local support provider, such as a system administrator, to perform local support of such support-enabled applications. A local support provider 50 is generally defined as one or more support personnel who are located within the same building, on the same private network or within the same organization as the customer.

A diagnostic information package 40 is compiled at the request of the customer at the customer site 24. The diagnostic information package further comprises information about configuration of the active application, application resources, and system resources used by the application 26. The configuration of the active application may include current configuration settings and initialization settings, and the application resources may include the status (e.g. up/down) of internal application processes, the application database, and current security settings on application directories. System resources can include the memory allocated or used by the active application, total system memory, the disk space used, etc.

The diagnostic information package 40 is transferred to the local support provider 50 across a communication line. The support tool 34 is located at the remote support to display and format the diagnostic support package. Data formats and diagnosis information are defined uniformly in the diagnostic information package for all the active applications. This means that an individual support person can diagnose many types of applications and view their separate diagnostic support packages in a common format. This reduces the cost of support in several ways. The support personnel spend less time on the telephone with customer, which reduces the vendor's support costs. Because the problem can be diagnosed quickly, it can also be fixed quickly. This reduces the cost of application downtime for the consumer. As a result, customers are happier with the application and those customers will be retained by the vendor.

It should be noted the support tool 34 is not designed primarily to have explicit control of the application. However, simple reconfiguration of the application may be enabled by the procedural interface or APIs. Configuration files or commands can be sent back to the active application to repair it.

Since this method and system uses a uniform set of APIs (or procedural interfaces), it enables any application that uses those APIs and follows the subscribed standards to deliver a diagnostic information package. Accordingly, the same set of API's can be built into multiple applications that will be running simultaneously on the same client computer. Each active application may have its own instance of the APIs in order to collect the diagnostic information package. If a greater amount of reusability is needed, the APIs may be configured as re-usable objects that can be loaded by the operating system once and accessed by multiple applications.

Another advantage of this invention is that it can provide an open set of APIs in conjunction with a software development kit (SDK) for integration into an unlimited number of products. This use of open standards allows third parties to tie into the support interfaces and processes also.

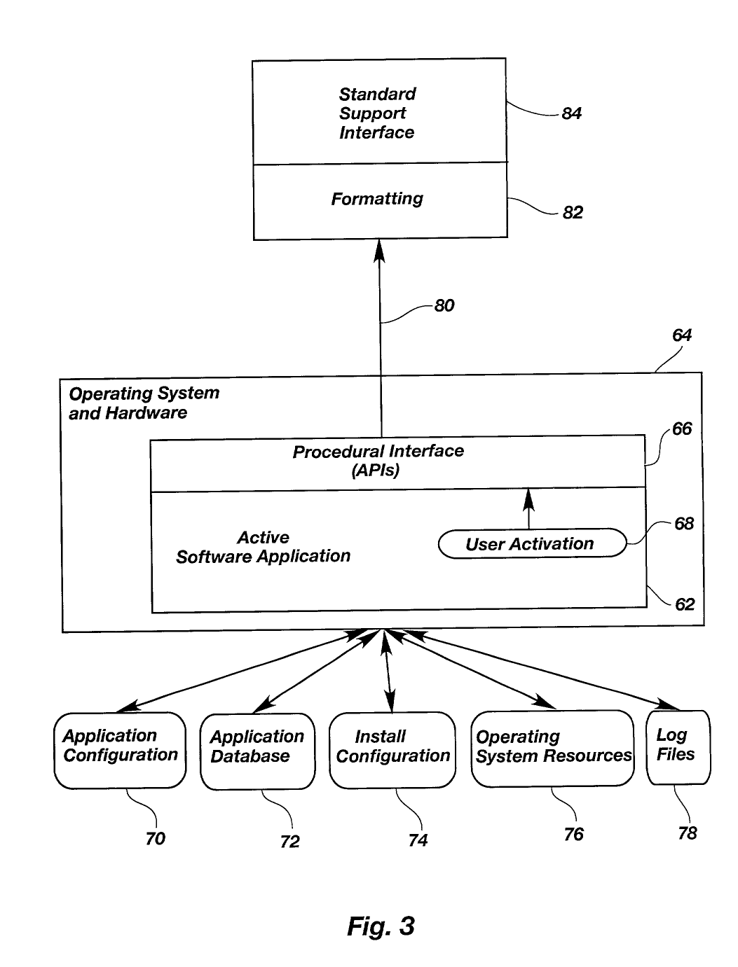

FIG. 3 is a block diagram illustrating a user-initiated system for sending a diagnostic information package to a support site. An active application 62 runs on a designated operating system and its related hardware 64. A procedural interface 66 (or APIs) is coupled to the active application. The user of the client computer activates 68 the collection of diagnostic data into the diagnostic information package.

Some examples of diagnostic data that may be collected are shown in FIG. 3. For example, the procedural interface may collect information about the application configuration 70, the application database 72, install configuration 74, operating system resources 76, hardware resources, and the application log files 78. After the diagnostic information package is collected, it is transmitted to the support site via a communications link 80. The communications link may be an Internet connection with a TCP/IP connection or another proprietary electronic connection. After the support site has received the diagnostic data it can then be formatted by a formatting module 82 coupled to the standard support interface 84. Of course, the formatting may also take place in the active application before the diagnostic data package is sent.

Sending a complete package of information to a support person is an advantage because of the speed of the information transfer. Without the collection of data, the time required for the support personnel to collect support information when they are remotely logged in (or over the phone) is much longer. There is also a certain amount of data that a support person will have difficulty accessing through a telephone call or email communication. A financial benefit of this system is that it enables new revenue streams for entities that may provide continuous support through the remote monitoring of applications.

It is important to differentiate this invention from a remote login to a computer or the use of a remote console for a network server (e.g., a Novell or Windows NT server). A remote login (e.g., rlogin) and a remote console are simply logins to a computer that allow the remote user to use computer resources as though they were physically located at the computer. After a person has remotely logged into the computer, they must evaluate the application and the environment through piece-wise probing to diagnose a problem. If support is performed in this way, the remote user can only access one element of the diagnosis information at a time. The present system addresses an application and its related environment in the aggregate

Conventionally, a remote support person has only been able to open one log or configuration file at a time after he has navigated to the location of the file. Then the support person must understand the format of the file and delve through the contents of the entire file. This is a very slow and tedious process. In contrast, the present invention captures all the diagnostic information quickly and easily. Another significant benefit is that the support person can look at a significant amount of data quickly because it has been pre-organized. The support tool interface can use the standard formatting to highlight important portions of files for a support person. Moreover, the support person can compare multiple diagnostic files side-by-side in the support tool without having to hunt for them and load or copy each file separately.

In a similar manner, some programs are able to connect directly to a personal computer through host software that provides remote, direct control of a computer. Examples of such programs are PC Anywhere and Carbon Copy. These programs suffer from the same issues as a remote login, remote console or a Telnet type of application. They do not provide an in-depth diagnosis mechanism, and only allow a user to look at the system as an end user.

The present invention is also significantly different from known devices for remotely monitoring computer hardware failure. Some hardware vendors provide a hardware expansion board (e.g., PCI board) for mounting into a computer or server to monitor the system's hardware performance, which then notifies users if a problem occurs. These types of devices use Simple Network Management Protocol (SNMP) to manage the nodes on an IP network or Desktop Management Interface (DMI).

In general, these systems are hardware level systems management consoles, where monitoring is a key activity. For example, such a system can be configured with network access back to the hardware provider. The hardware provider's support person can log into the system and use pre-loaded utilities to debug aspects of the customer's hardware. One such utility might be a network node manager. SNMP and DMI allow the user to monitor system problems at a hardware level. SNMP only provides a few standards that are adhered to. DMI is largely for hardware issues with personal computer (PC) environments and it monitors the hardware at a low level, including the device driver or operating system level.

Hardware monitoring systems do not provide an application level support tool for management and diagnosis of problems, where diagnosis is done by the support personnel or a system management console, if available. In fact, hardware management software might even receive an SNMP notification (or trap) from the hardware and then the support tool of the present invention would be started by the hardware management software. This enables the local administrator or remote support personnel to diagnose and/or correct the problem from the support tool that was activated automatically by the hardware monitoring system. Another example of a hardware monitoring tool is a system that tries to monitor disk usage and related system behaviors in an effort to predict upcoming failures of the customer's environment. Monitoring disk usage and similar benchmarks only provides a monitoring role that does not enable diagnosis capabilities.

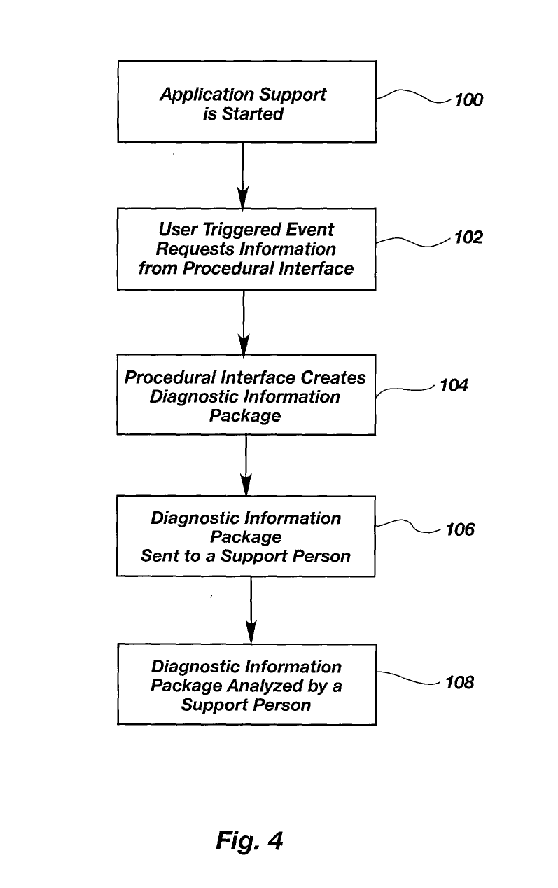

As illustrated in FIG. 4, this invention includes a method for allowing remote diagnosis of an active application and its related environment on a client computer. A preparation step is that application support is started 100 through a phone call, e-mail, or another communication method. The next step is requesting a diagnostic information package from the active application 102. This is done when a user triggers an event such as clicking a button in the graphical interface.

The next step is that the procedural interface collects the diagnostic information package for the active application on the client computer 104. The collection of the diagnostic information package is done programmatically which allows a detailed compilation of critical information to be sent to a support person. The next step is sending the diagnostic information package to a support location 106. The diagnostic information package may then be analyzed immediately by a support person at the support location 108. This can be done while the support person is on the telephone with the user or after their telephone conversation. Optionally, data sent in the diagnostic information package either may be stored in a database or on a storage medium until a support person is available to analyze the information.

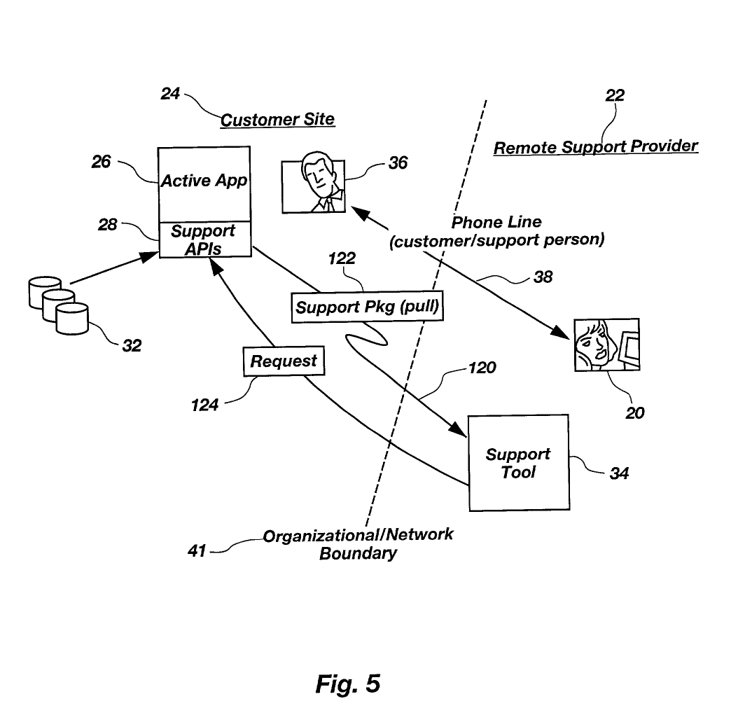

FIG. 5 is similar to FIG. 1 with the addition of another element. The figure illustrates the relationship between a customer site 24 and a remote service provider 22 who is pulling the diagnostic information package 122 from the customer site. Specifically, a support person 20 is able to use the support tool via a communications link 120 to pull (i.e., request) the diagnostic support package from procedural interface 28 or APIs of the active application 26. The remote request 124 may be made via a private network connection, a dial-up connection, the Internet, a wireless connection, or through similar telecommunication and networking methods. In any case, the diagnostic information package is sent back to the remote support provider for troubleshooting and analysis. The major difference between the embodiment in FIG. 5 and FIG. 1 is that a support person is able to request the information without customer or user intervention. This is effective because fast, accurate troubleshooting can take place without significant discussion with the user. This embodiment also involves a support person who is located outside the customer's organization or private network 41.

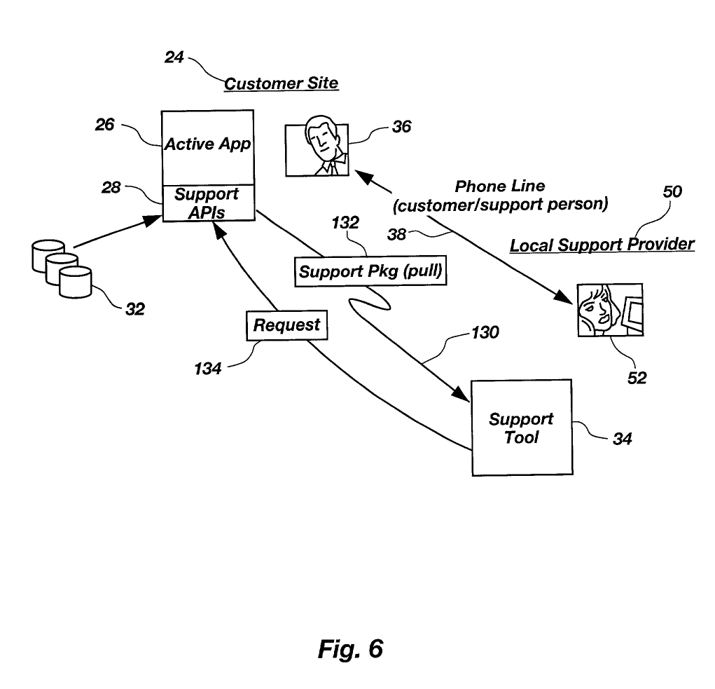

FIG. 6 is similar to FIG. 2 with the addition of another element to form this embodiment of the invention. FIG. 6 illustrates the relationship between a customer site 24 and a local support person 52 who is pulling 130 a diagnostic information package 132 from the customer site. In this case, the local support person is able to use the support tool 34 via a communications link to request 134 and then pull 130 the diagnostic support package from procedural interface (or APIs) of the active application 26.

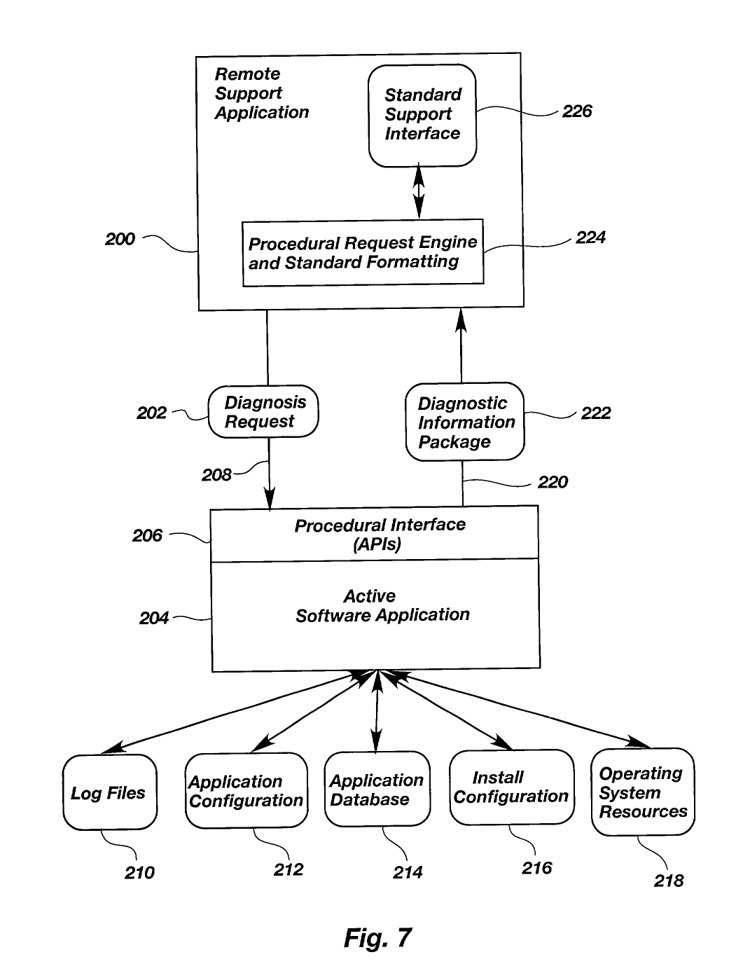

FIG. 7 is a block diagram illustrating the request of a diagnostic information package 222 from an active application 204 at a remote client site. A remote support application 200 is used by support personnel at the support site, which allows them to remotely diagnose an active application on a client computer (not shown). The support person first makes a diagnosis request 202 through the remote support application. The diagnosis request is delivered through a communications link 208. A procedural interface 206 is associated with the active application 204. A pre-defined set of diagnosis queries and functions is contained in the procedural interface to collect information about the operability of the active application. A data collection component coupled to or included as part of the procedural interface is configured for combining and formatting a diagnostic data package received from the pre-defined set of diagnosis queries and functions. The pre-defined diagnosis queries and functions retrieve information relevant to the active application such as the log files 210, application configuration 212, application database 214, install configuration 216, and operating system resources 218.

The communications component 208 transfers the diagnostic data package 222 to a support location. The remote support application 200 is configured to receive the diagnostic data package 222 from the communications component. A user interface 226 in the remote support application is accessible to the support personnel. This user interface provides a standard support interface 226 for multiple applications that use the procedural interface and allow the support person to view the support data as arranged by a standard formatting module 224.

In an alternative embodiment, the procedural interface enables changes to the configuration of the application, application resources and the system resources that the application is using. Specifically, this may entail sending repaired files from a support site to the client computer to repair problems with the active application and its related environment. In addition, an automated system or timed procedure can be prepared to request the diagnostic information package, as opposed to having a support person request the information. Optionally, the user may initiate a support call by sending a support package to the support location.

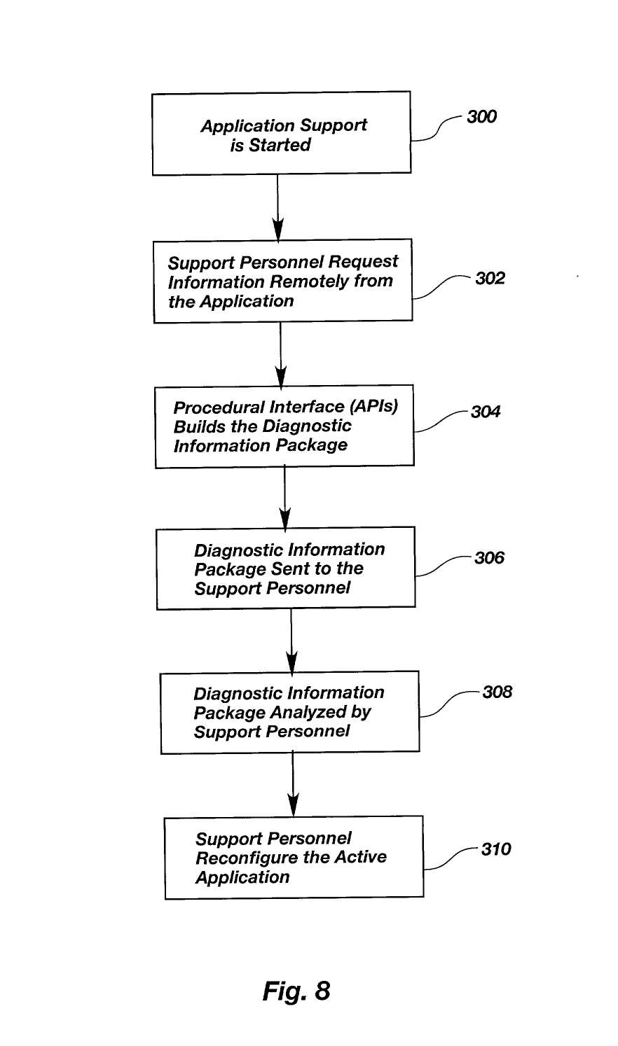

FIG. 8 is a flow chart illustrating a method for transferring a diagnostic information package to a support site that is initiated by a support person. First, application support is started 300 through a phone call, e-mail, or another communication method. Next, the support personnel request a diagnostic information package from the active application 302. This request is made when the support personnel trigger an event such as clicking a button or selecting a menu item.

After the initial request, the procedural interface collects the diagnostic information package for the active application 304 on the client computer. The next step is sending the diagnostic information package to the support personnel 306.

Circumventing the end user in the support process may increase the speed and accuracy of the support offered. The diagnostic information package may then be analyzed immediately by support personnel at the support location 308. This can be done while a support person is on the telephone with the user or at a later point in time. An optional step is to allow the support personnel to remotely reconfigure the active application by sending files or commands back to the active application 310.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in form, function, manner of operation, and use may be made, without departing from the principles and concepts of the invention as set forth in the claims.

What is claimed is:

1. A method for enabling remote diagnosis of an active application and its related environment on a client computer from a support location, comprising the steps of:
requesting a diagnostic information package relating to the active application;
collecting the diagnostic information package relating to the active application, using a procedural interface that programmatically collects the diagnostic information package; and
sending the diagnostic information package to the support location in response to the request for the diagnostic information package.

2. A method as in claim 1, wherein the step of collecting the requested diagnostic information package further comprises the step of collecting information about configuration of the active application, application resources, and system resources used by the active application.

3. A method as in claim 1, further comprising the step of enabling a user to send the diagnostic information package relating to the active application to the support location.

4. A method as in claim 1, further comprising the step of enabling a support person to request the diagnostic information package relating to the active application.

5. A method as in claim 1, further comprising the step of enabling an automated system to request the diagnostic information package relating to the active application.

6. A method as in claim 1, further comprising the step of utilizing a support tool located at the support location for displaying and interpreting data from the diagnostic information package.

7. A method as in claim 6, further comprising the step of enabling a support person to use the support tool to diagnose and interpret the diagnostic support package for the active application and its related environment.

8. A method as in claim 6, further comprising the step of sending files to the client computer to repair a problem diagnosed with the active application.

9. A method as in claim 1, further comprising the step of coupling a procedural interface to a plurality of active applications.

10. A method as in claim 1, further comprising the step of using a support tool located at the support location to allow a support person to interpret the diagnostic information package.

11. A method as in claim 1, further comprising the step of defining data fomats and diagnostic information uniformly for each of a plurality of active applications.

12. A system for enabling a support person at a support location to remotely diagnose an active application and its related environment on a client computer, comprising:
a procedural interface, couplable to the active application, wherein the procedural interface enables the collection of a diagnostic information package concerning the active application and its related environment, the procedural interface further comprising:
a communications component, associated with the procedural interface, configured to enable transfer of the diagnostic information package to the remote support location.

13. A system as in claim 12, wherein the diagnostic information package further comprises information about the configuration of the active application, application resources, and system resources used by the active application.

14. A system as in claim 12, wherein the diagnostic information package has uniformly defined data formats and diagnosis information for each active application.

15. A system as in claim 12, further comprising a support tool located at the support location to allow a support person to interpret the diagnostic information package.

16. A system as in claim 1, further comprising a single procedural interface that is coupled to a plurality of active applications.

17. A system as in claim 1, further comprising a plurality separate instances of the procedural interface that are coupled to each of a plurality of active applications.

18. A system for allowing support personnel at a support location to remotely diagnose an active application and its related environment on a client computer, comprising:
a procedural interface, associated with the active application, having pre-defined diagnosis queries and functions to retrieve information regarding operability of the active application;
a data collection component, coupled to the procedural interface, configured for combining and formatting the information received from the pre-defined diagnosis queries and functions into a diagnostic information package;
a communications component, associated with the procedural interface, configured to control transferring of the diagnostic information package to the support location; and
a remote support tool, configured for receiving and displaying the diagnostic information package transferred by the communications component, having a user interface that is accessible to the support personnel.

19. A software support system as in claim 18, wherein the remote support tool is used by the support personnel to view the diagnostic data package and identify problems in the active application.

20. A software support system as in claim 18, wherein the procedural interface enables changes to the configuration of the active application, application resources and the system resources that the application is using.

21. A software support system as in claim 18, wherein the diagnostic data package has defined uniform data formats and diagnosis information.

22. A software support system as in claim 18, wherein a user activates the transfer of the diagnostic data package that is sent to the support location.

23. A software support system as in claim 18, wherein support personnel activate a transfer of the diagnostic data package through the remote support tool.

24. An article of manufacture, comprising:
a computer usable medium having computer readable program code means embodied therein for enabling remote diagnosis of an active application and its related environment on a client computer from a support location, the computer readable program code means in said article of manufacture comprising:
computer readable program code means for requesting a diagnostic information package relating to the active application;
computer readable program code means for collecting the diagnostic information package relating to the active application, using a procedural interface that programmatically collects the diagnostic information package; and
computer readable program code means for sending the diagnostic information package to the support location in response to the request for the diagnostic information package.
